(19) United States
(12) Patent Application Publication
(10) Pub. No.: US 2015/0159431 A1
(43) Pub. Date: Jun. 11, 2015

(54) SAFETY RETAINER FOR DOUBLE-TRACK CURTAIN CONTROL DEVICE

(71) Applicant: UNI-SOLEIL ENT. CO., LTD., Tainan City (TW)

(72) Inventor: YU-TING KAO, TAINAN CITY (TW)

(73) Assignee: UNI-SOLEIL ENT. CO., LTD., Tainan City (TW)

(21) Appl. No.: 14/102,720

(22) Filed: Dec. 11, 2013

(51) Int. Cl. E06B 9/382

(52) U.S. Cl. CPC E06B 9/382

(57) ABSTRACT

A safety retainer for double-track curtain cords is revealed. The safety retainer includes an outer base, an inner base, elastic members, a fixing base, and threaded parts. A through hole is disposed on each of two sides of the outer base and a separating pin is arranged between the through holes for separating space into and a first fixing hole and a second fixing hole that are mounted with a bead chain and a cord respectively. The inner base and the elastic member are mounted into the through hole of the outer base. The fixing base is covered over and connected to the outer base for stopping the elastic members. Then the inner base, outer and fixing bases are fastened on a wall surface by the threaded parts. Thereby the bead chain and the cord are positioned safely and children won't get tangled in them.

### BACKGROUND OF THE INVENTION

1. Fields of the Invention

The present invention relates to a safety retainer for double-track curtain control devices, especially to a safety retainer for double-track curtain control devices that stably position cords and bead chains used for control extension/retraction and rotation of curtains. Thus the cords and beads are not dangling, tangled or accessed by children and causing safety problems.

2. Descriptions of Related Art

Not only functionally provide privacy and shields from the sun but also serve as beautiful decorative elements. According to functions and applications, curtains/blinds are divided into various groups including Roman blinds, roller blinds, Venetian blinds, etc. The curtain available now mainly includes a fabric moved in a track so as to extend and retract the curtain. The movement of the fabric is controlled by a cord or a bead chain.

Generally, most of curtain cords are hanging with a weight thereunder. When the wind blows through the window, noises are generated due to the weight on the cord bump into the wall. Moreover, the potential hazards the curtain cord pose are mentioned in some news before. The dangling and loose cords form loops and children are likely to get strangled and die while they are playing. Or they may jump and try to access the cord and thus fall out of the window and become serious injured.

In order to solve the above shortcomings, refer to Taiwanese Pat. Pub. No. M415669, a safety retainer for curtain controllers is revealed. The safety retainer is mainly used to fix a cord that controls extension/retraction of curtains. The safety retainer consists of an outer seat, an inner seat and two elastic members. The outer seat consists of two corresponding through holes and a connection rod that is extended from a bottom surface of the through hole and having a penetrating center. The two through holes are communicating with each other by a channel. An end surface of the outer seat correspondingly to the channel is arranged with a penetrating fixing hole. The inner seat is arranged with two corresponding clamping blocks and a connection piece connecting the two clamping blocks. A fixing hole is set on the connection piece so that the clamping blocks and the connection piece are mounted into the through holes and the channel of the outer base. A connection rod with a penetrating center and corresponding to the connection rod of the outer seat is set on the bottom of the clamping block. The two elastic members are mounted in the connection rods of the inner and outer seats respectively.

However, the above device is originally designed to fix bead chains. The curtains available now have different types and specifications. Some are able to be rolled upward/downward (or retracted to left/right side) and the blades are rotatable. Thus both a cord and a bead chain are required for respective positioning and operation. For easy operation of users, the cord and the bead chain are usually arranged at the same side of the track. Thus the cord and the bead chain are easy to get tangled. There is room for improvement and a need to provide a safety retainer for double-track curtain control devices with high practical value.

### SUMMARY OF THE INVENTION

Therefore it is a primary object of the present invention to provide a safety retainer for double-track curtain control devices that fixes and positions a cord and a bead chain used for control of curtains. Thus the cord and the bead chain are not dangling, tangled or easily accessed by children and having potential hazards.

In order to achieve the above object, a safety retainer for double-track curtain control devices of the present invention includes an outer base, an inner base, elastic members, a fixing base, and threaded parts. Each of two sides of the outer base is arranged with a through hole and a separating pin is arranged between the two through holes so as to separate the space into and a first fixing hole and a second fixing hole used for mounting a bead chain and a cord respectively. Then the inner base and the elastic member are mounted into the through hole of the outer base correspondingly. The fixing base is covered over and connected to the outer base for stopping the elastic members. Next the threaded parts are used to fasten the inner base, the outer base and the fixing base on a wall surface. Thus the bead chain and the cord are not easy to form loops and children will not get tangled in the cords.

Moreover, a stop slot is extended from the second fixing hole and the separating pin is disposed with a sliding slot.

The inner base further includes mounting rods corresponding to and mounted with the through holes of the outer base respectively and a connection portion located between the two mounting rods. A sliding block corresponding to and mounted with the sliding slot of the separating pin is disposed on the connection portion.

The mounting rod is arranged with mounting guiding strips therearound while guiding slots are disposed in the through hole of the outer base correspondingly.

The fixing base is arranged with hooks that are corresponding to and mounted with the through holes of the outer base.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is an explosive view of an embodiment according to the present invention;

FIG. 2 is a cross sectional view of an assembled embodiment according to the present invention;

FIG. 3 is a schematic drawing showing an embodiment in use according to the present invention;

FIG. 4 is a cross sectional view of an embodiment assembled at a wall surface according to the present invention;

FIG. 5 is a schematic drawing showing an embodiment in use according to the present invention;

FIG. 6 is another schematic drawing showing an embodiment in use according to the present invention.

### DETAILED DESCRIPTION OF THE PREFERRED EMBODIMENT

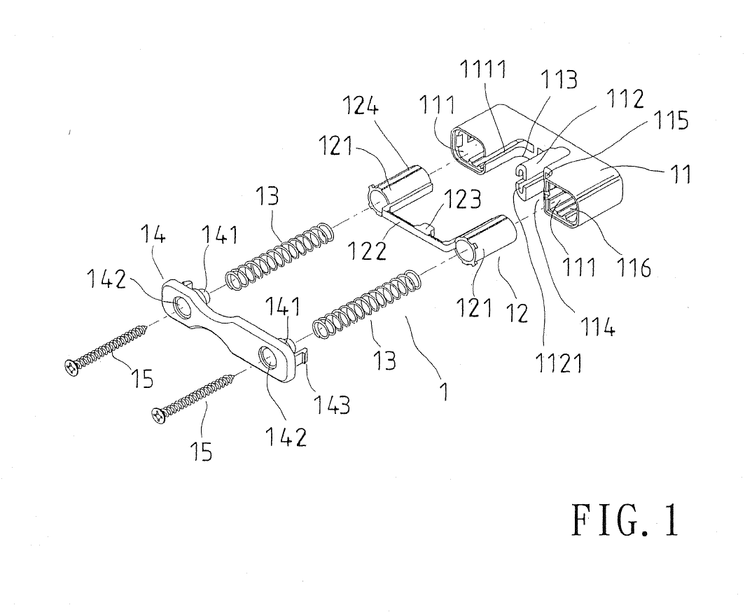

Refer to FIG. 1, a safety retainer 1 for double-track curtain control devices includes an outer base 11, an inner base 12, two elastic members 13, a fixing base 14, and two threaded parts 15.

A through hole 111 is disposed on each of two sides of the outer base 11 and a penetrating slot 1111 is mounted on an inner side of the through hole 111. A separating pin 112 is arranged between the two through holes 111 so as to separate the space into and a first fixing hole 113 and a second fixing hole 114 for mounting a bead chain 2 and a cord 3 respectively. The separating pin 112 is disposed with a sliding slot 1121.

The inner base 12 consists of two hollow mounting rods 121 corresponding to the through holes 111 of the outer base 11 respectively, a connection portion 122 located between the two mounting rods 121 and corresponding to the penetrating slot 1111 of the outer base 11, and a sliding block 123 corresponding to the sliding slot 1121 of the separating pin 112 and disposed on the connection portion 122.

The two elastic members 13 are mounted into the hollow mounting rods 121 of the inner base 12 respectively.

The fixing base 14 is arranged with two mounting pins 141 corresponding to the mounting rods 121 respectively. A through hole 142 is formed on a center of the mounting pin 141. The fixing base 14 is connected to and fixed with the outer base 11 while the mounting pin 141 compresses the elastic member 13 correspondingly.

Each of the two threaded parts 15 are passed through the through hole 142 of the fixing base 14, the elastic member 13, the hollow mounting rod 121 of the inner base 12 and the through hole 111 of the outer base 11 correspondingly so as to fix the safety retainer 1 on the position required.

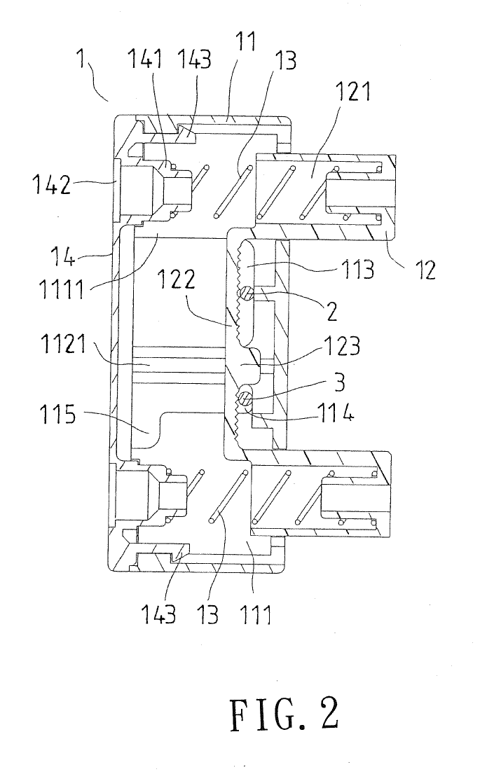

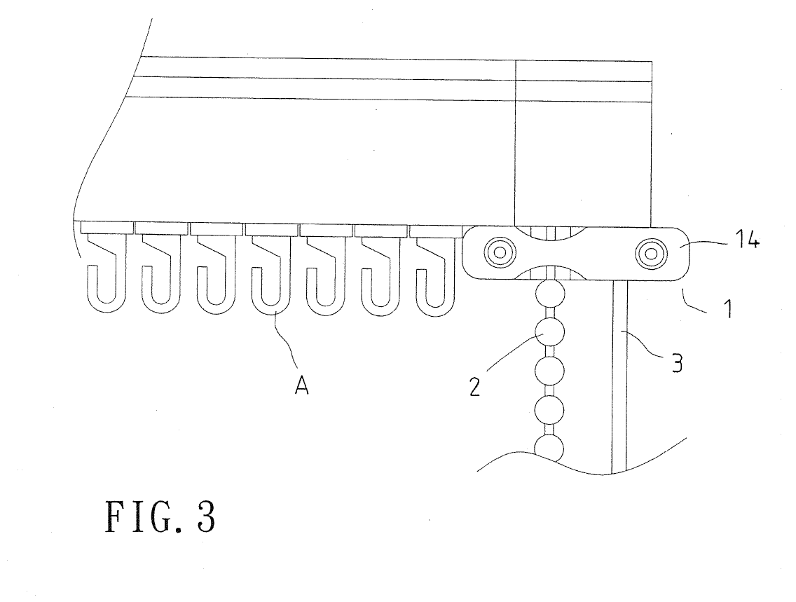

Refer from FIG. 1 to FIG. 3, while being assembled, first the bead chain 2 and the cord 3 are disposed in the first fixing hole 113 and the second fixing hole 114 respectively. Then the hollow mounting rods 121 are mounted into the through holes 111 and the elastic members 13 are arranged into the hollow mounting rods 121 for setting the inner base 12 in the outer base 11. Next fix and connect the fixing base 14 to the outer base 11 by hooks 143 arranged at the fixing base 14. Then the elastic members 13 are disposed around the mounting pins 141 of the fixing base 14 respectively. At the moment, the hollow mounting rod 121 is against by the elastic member 13. Mounting guiding strips 124 are arranged around the mounting rod 121 while guiding slots 116 are disposed in the through hole 111 of the outer base 11 correspondingly. Thus the mounting rods 121 is guided and sliding in the through hole 111. The hollow mounting rods 121 of the inner base 12 are projecting from the through hole 111, as shown in FIG. 2.

During the sliding of the mounting rods 121, the sliding block 123 of the inner base 12 is also moved and sliding in the sliding slot 1121 of the separating pin 112 and so is the connection portion 122 in the penetrating slot 1111 of the outer base 11. After the connection portion 122 and the sliding block 123 being moved to the rear end of the penetrating slot 1111 and the sliding slot 1121 respectively, the bead chain 2 and the cord 3 are clamped and fixed in the first fixing hole 113 and the second fixing hole 114 correspondingly by the connection portion 122. While curtains are retracted to the top or the left/right sides, the safety retainer 1 is used to fasten the bead chain 2, the cord 3 and curtain carriers A at certain positions. Thus the bead chain 2 and the cord 3 are fixed, not easily pulled to make the curtain fabric expand while a set of curtain being displayed.

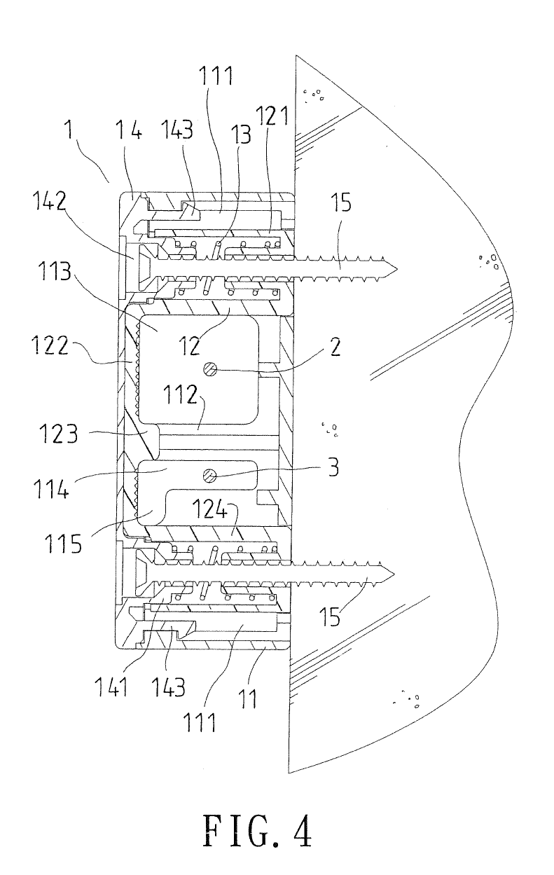

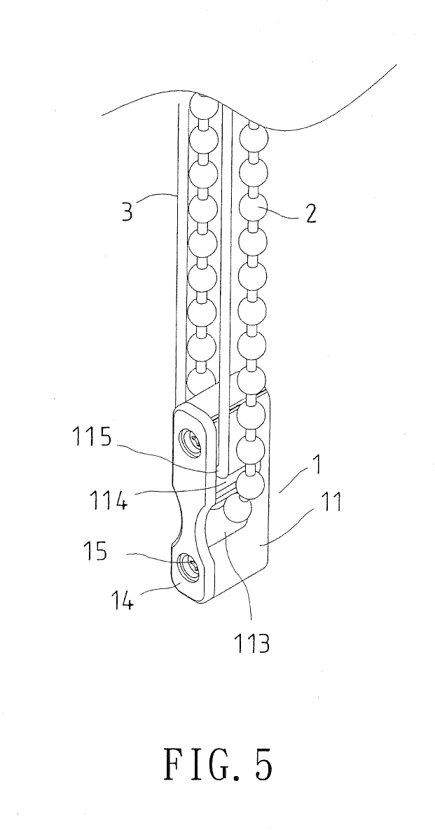

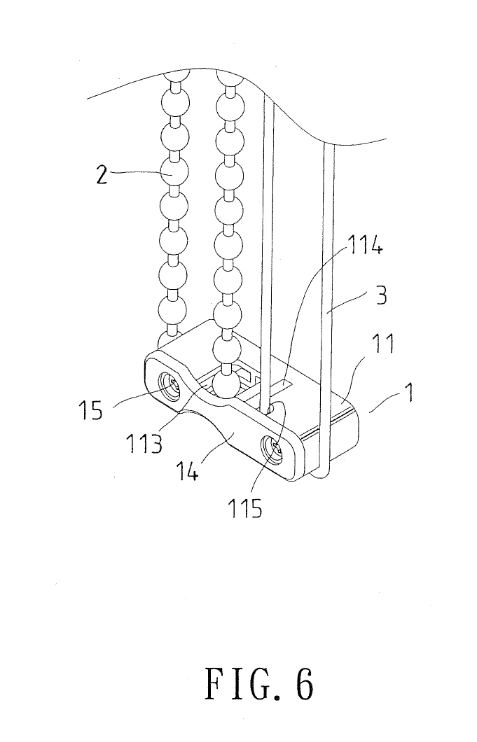

Refer to FIG. 4, FIG. 5 and FIG. 6, while the user intend to fix the safety retainer 1 on the positioned required, two threaded parts 15 are used to pass through the through hole 142 of the fixing base 14, the elastic member 13, the hollow mounting rod 121 of the inner base 12 and the through hole 111 of the outer base 11 so as to fix the safety retainer 1 on the required position. Then the mounting rod 121 of the inner base 12 is moved back into the through hole 111 of the outer base 11 while the elastic member 13 located in the fixing base 14 and the hollow mounting rod 121 is compressed. As to the connection portion 122, it doesn't clamp and stop the bead chain 2 and the cord 3 in the first fixing hole 113 and the second fixing hole 114 respectively.

Refer to FIG. 5, when the user want to separate and stop the bead chain 2 and the cord 3, the cord 3 is mounted into a stop slot 115 extended from the second fixing hole 114. Thus there is a certain distance between the bead chain 2 and the cord 3.

The direction of the assembly according to the present invention can be horizontal or vertical, depending on the environment or habits of the users, as shown in FIG. 5 and FIG. 6. Thus the bead chain 2 and the cord 3 are safely positioned in the safety retainer 1 for preventing children from hazards the cord 3 can pose.

Compared with the structure of the safety retainer available now, the present invention has following advantages:

1. The head chain and the cord are positioned safety by the safety retainer of the present invention respectively. Thus there is no noise generated or safety problems caused by the bead chain or the cord.

2. By the design of the inner base and outer base corresponding to elastic members, the safety retainer can fix the bead chain and the cord before it being assembled on a wall surface. Thus the user can position the safety retainer together with the bead chain and the cord easily.

3. By the mounting guiding strips around the mounting rod and the corresponding guiding slots disposed in the through hole of the outer base guided and assembled with each other, the safety retainer is assembled and positioned stably.

4. Due to the arrangement of the first fixing hole and the second fixing hole, the bead chain and the cord are stopped therein respectively. Thus the bead chain and the cord are not tangled. Moreover, a stop slot id extended from the second fixing hole. Thus the cord is restricted to be operated in the stop slot only and there is a certain distance between the bead chain and the cord.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A safety retainer for double-track curtain control devices comprising:
an outer base having a through hole disposed on each of two sides thereof and a separating pin arranged between the two through holes to separate the space into and a first fixing hole and a second fixing hole for mounting a bead chain and a cord respectively; guiding slots are arranged around the through hole and a penetrating slot is mounted on an inner side of the through hole while the separating pin is disposed with a sliding slot; a stop slot is extended from the second fixing hole;
an inner base having two hollow mounting rods corresponding to and mounted with the through holes of the outer base respectively and a connection portion located between the two mounting rods; the mounting rod is disposed with mounting guiding strips corresponding to the guiding slots of the through hole while the connection portion is corresponding to the penetrating slot of the outer base; and a sliding block corresponding to the sliding slot of the separating pin is disposed on the connection portion;
two elastic members that are mounted into the hollow mounting rods of the inner base respectively; and
a fixing base that is arranged with two mounting pins corresponding to the mounting rods respectively and hooks corresponding to the through holes of the outer base respectively; the mounting pin is against the elastic member and a through hole is formed on a center of the mounting pin; the fixing base is connected to and fixed on the outer base by the hook mounted into the through hole.

2. The device as claimed in claim 1, wherein the safety retainer further includes two thread parts; the threaded part is passed through the through hole of the fixing base, the elastic member, the hollow mounting rod of the inner base and the through hole of the outer base correspondingly so as to fix the safety retainer on required positions.
